(19) United States
(12) Patent Application Publication
(10) Pub. No.: US 2026/0217589 A1
(43) Pub. Date: Jul. 30, 2026

(54) Methods of Pedestal Shaping in Optical Fibers and Related Structures

(71) Applicant: The Government of the United States of America, as represented by the Secretary of the Navy, Arlington, VA (US)

(72) Inventors: Daniel L. Rhonehouse, Huntingtown, MD (US); Colin C. Baker, Alexandria, VA (US); Jasbinder S. Sanghera, Ashburn, VA (US); Shyam S. Bayya, Leesburg, VA (US)

(73) Assignee: The Government of the United States of America, as represented by the Secretary of the Navy, Arlington, VA (US)

(21) Appl. No.: 19/004,968

(22) Filed: Dec. 30, 2024

Related U.S. Application Data
(60) Provisional application No. 63/618,627, filed on Jan. 8, 2024.

(51) Int. Cl. C03B 37/027; C03B 37/012

(52) U.S. Cl. CPC C03B 37/027; C03B 37/01211

(57) ABSTRACT

Some embodiments of the present disclosure provide methods of forming optical fibers. For example, a fiber preform may include a preform core, a preform pedestal surrounding the preform core, and a preform clad surrounding the preform pedestal, and the fiber preform may include a plurality of voids adjacent an interface between the preform pedestal and the preform clad. The fiber preform may be drawn into the optical fiber so that the optical fiber includes a fiber core, a fiber pedestal surrounding the fiber core, and a fiber clad surrounding the fiber pedestal. Moreover, the fiber preform may be drawn so that the voids collapse to provide a non-cylindrical interface between the fiber pedestal and the fiber clad. Related preforms are also disclosed.

### CROSS-REFERENCE TO RELATED APPLICATIONS

This application is a Nonprovisional Utility patent application and claims the benefit of priority under 35 U.S.C. Sec. 119 based on U.S. Provisional Patent Application No. 63/618,627 filed on Jan. 8, 2023. The disclosure of Provisional Application No. 63/618,627 and all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #211823-US2.

### TECHNICAL FIELD

The present disclosure relates to methods of forming optical fibers and related preforms.

### BACKGROUND OF THE INVENTION

High-energy lasers (HELs) have been developed for directed energy systems because they may offer a highly effective and affordable defense capability. Fiber lasers generally include an optical medium in the form of a fiber with a typically circular/cylindrical doped core region surrounded by one or more circular/cylindrical cladding regions (also referred to as clad regions, cladding, or clad). One method to produce such fibers is vapor phase deposition either external or internal to a substrate. In some instances, coaxial pumping of the fiber by a light source (such as diodes or another fiber laser) into the cladding region excites the core region. Light from the pump travels the length of the fiber. At times the light travels through the core region and is absorbed by the core region exciting active ions in the core region. The excited active ions then emit the desired wavelength upon relaxation to the ground state. Under certain conditions of numerical aperture, radius of the core, and wavelength of the light, the fiber will remain in strictly single mode operation. The fiber “V number” dictates single mode operation, where:

$$V = 2 π aNA / λ < 2.405 . \qquad Equation 1$$

In Equation 1, the core radius, NA, is the core numerical aperture, and λ is the wavelength of light propagating in the fiber. It is evident here that single mode operation is met when the V number is less than 2.405. In order to increase the output power of a given laser, it is sometimes desirable to increase the diameter of the core region to reduce/avoid detrimental nonlinear optical effects that degrade output power and the “quality” of the light. The increase in core diameter thus decreases power density, thus reducing/averting these effects. For a given numerical aperture, increasing the core region radius may eventually lead to multimode operation, where the condition V<2.405 is not met. Decreasing the numerical aperture of the core can help reduce/prevent transition to multimode operation, however, the core numerical aperture is nearly always fixed by the dopant concentration, where high refractive index dopants will increase this value. This is especially true for many amplifier and laser applications where increased concentrations of core dopants may be useful/required to provide high output powers and/or energies.

To that end, a fiber structure with a circular undoped region of tailored numerical aperture known as the “pedestal” may be formed surrounding the core to allow for single mode operation at larger core diameters (see, Reference [1], a full citation of which is provided below) as shown in the cross-section of FIG. 1 and the graph of FIG. 2. Here the fiber core 101 is being “tricked” into single mode operation, because the core numerical aperture is now the refractive index difference between the core 101 and the pedestal 103, where the pedestal 103 can be tailored to a specific refractive index. In standard fibers with a pedestal region, the pedestal may have an additional surrounding cladding 105 (also referred to as clad) of lower refractive index into which the pump source is directed. Here the pump light may be forced into the pedestal 103, and then into the core 101 by virtue of their respective increases in refractive index. As shown in FIG. 2, a difference between refractive indices of core 101 and pedestal 103 may be less than a difference between refractive indices of pedestal 103 and clad 105.

Notwithstanding the fiber structures discussed above with respect to FIGS. 1 and 2, there continues to exist a demand for fiber structures providing performance improvements and methods of forming such fibers.

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of subject matter described and claimed herein.

According to some embodiments of inventive concepts, a method of forming an optical fiber includes providing a fiber preform including a preform core, a preform pedestal surrounding the preform core, and a preform clad surrounding the preform pedestal. The fiber preform includes a plurality of voids adjacent an interface between the preform pedestal and the preform clad. The fiber preform is drawn into the optical fiber so that the optical fiber includes a fiber core, a fiber pedestal surrounding the fiber core, and a fiber clad surrounding the fiber pedestal. Moreover, the fiber preform is drawn so that the voids collapse to provide a non-cylindrical interface between the fiber pedestal and the fiber clad.

According to some other embodiments of inventive concepts, a method of forming an optical fiber includes providing a preform clad having a cylindrical interior and exterior. The preform clad is reshaped so that the interior of the preform clad is non-cylindrical. After reshaping the interior of the preform clad, a preform pedestal and a preform core are formed on the non-cylindrical interior of the preform clad to define a fiber preform including the preform core, the preform pedestal, and the preform clad having the interior that is non-cylindrical. After forming the preform pedestal and the preform core to define the fiber preform, the fiber preform is drawn into the optical fiber so that the optical fiber includes a fiber core, a fiber pedestal surrounding the fiber core, and a fiber clad surrounding the fiber pedestal.

According to still other embodiments of inventive concepts, a fiber preform includes a preform core, a preform pedestal, and a preform clad. The preform pedestal surrounds the preform core, and the preform clad surrounds the preform pedestal. Moreover, the fiber preform includes a plurality of voids adjacent an interface between the preform pedestal and the preform clad.

According to yet other embodiments of inventive concepts, a fiber preform include a first preform, a second preform, and a plurality of rods. The first preform defines a preform clad having an opening therethrough. The second preform is in the opening defined by the first preform, and the second preform includes a preform core and a preform pedestal surrounding the preform core. The plurality of rods are spaced apart in the opening defined by the first preform between the first and second preforms, with voids being defined between the rods.

### BRIEF DESCRIPTION OF DRAWINGS

Examples of embodiments of inventive concepts may be more clearly understood from the following detailed description taken in conjunction with the accompanying drawings in which:

FIG. 1 is a cross-sectional view illustrating core, pedestal, and clad regions of an optical fiber;

FIG. 2 is a graph illustrating different refractive indices of the core, pedestal, and clad regions of the optical fiber of FIG. 1;

FIGS. 3A, 3B, and 3C are cross sectional views illustrating different pedestal shapes of optical fibers having core, pedestal, and clad regions;

FIG. 4A is a cross-sectional view illustrating a fiber preform including tubes and rods between pedestal and clad regions according to some embodiments of inventive concepts;

FIG. 4B is a cross-sectional view illustrating a fiber that results from the fiber preform of FIG. 4A according to some embodiments of inventive concepts;

FIGS. 4C, 4D, and 4E are cross sectional views illustrating fiber preforms with drilled holes according to some embodiments of inventive concepts;

FIG. 5 illustrates a fiber preform according to some embodiments of inventive concepts;

FIG. 6A is a magnified view of the preform core, preform pedestal, preform rods, and preform tubes/capillaries of FIG. 5;

FIG. 6B is cross sectional view of a fiber resulting from the preform of FIGS. 5 and 6A;

FIG. 7A is a cross-sectional view of a preform clad with tubes according to some embodiments of inventive concepts;

FIG. 7B is a cross-sectional view of a modified preform clad that results from the preform clad of FIG. 7A after heating according to some embodiments of inventive concepts;

FIG. 7C is a cross-sectional view of a fiber preform provided by forming a preform pedestal and a preform core in the preform according to some embodiments of inventive concepts;

FIG. 8A is a cross-sectional view of a pedestal preform with trenches according to some embodiments of inventive concepts;

FIG. 8B is a cross-sectional view of preform including a preform clad and the pedestal preform of FIG. 8A according to some embodiments of inventive concepts;

FIG. 9A is a cross-sectional view of a clad preform with tubes according to some embodiments of inventive concepts;

FIG. 9B is a cross-sectional view of a modified clad preform after heating the preform of FIG. 9A according to some embodiments of inventive concepts; and

FIG. 9C is a fiber preform with pedestal and core preforms formed in the modified clad preform of FIG. 9B according to some embodiments of inventive concepts.

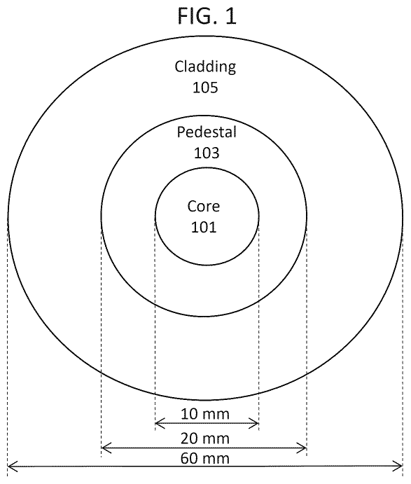

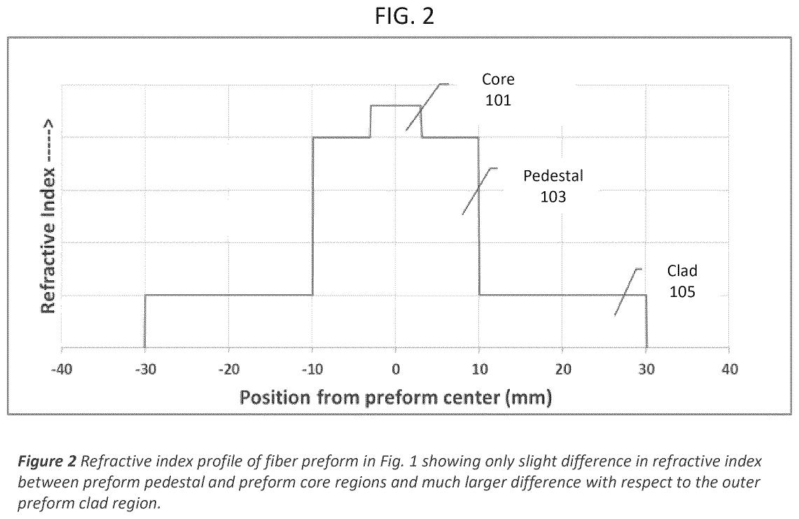

### DETAILED DESCRIPTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and conveniences of explanation.

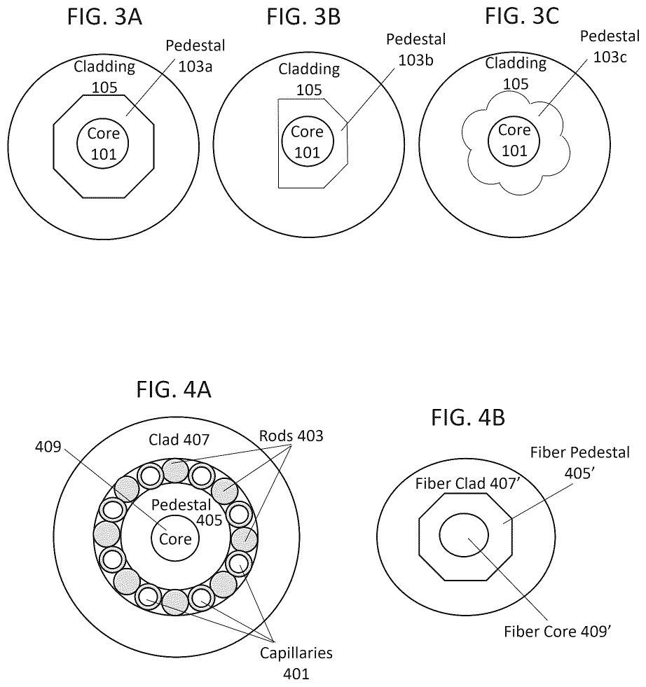

It may be desirable to pump light directly into a fiber pedestal region to couple light into the core in a shorter length with greater effectiveness. A further enhancement of coupling to the fiber core may be provided by shaping of the pedestal region to a non-circular form as shown in FIGS. 3A, 3B, and 3C, causing pump light to be directed to the core even more quickly, where so called “donut modes” may be reduced/avoided. By way of example, pedestal 103a of FIG. 3A may have an octagonal shape, pedestal 103b of FIG. 3B may have a “D” shape, or pedestal 103c may have a “lobed” shape. The formation of core, pedestal, and clad layers/regions having non-circular/non-cylindrical shapes may be difficult using a standard vapor phase apparatus. Improved methods to provide non-circular/non-cylindrical pedestals may thus be desirable.

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. In the drawings, like reference numerals refer to like elements throughout and the sizes of each of the elements may be exaggerated for clarity and conveniences of explanation.

The present disclosure describes methods to alter shapes of pedestal regions of optical fibers. In some embodiments of the present disclosure, methods use viscous flow of material surrounding a matrix of cavities upon the application of heat or a combination of heat and vacuum or other force to bring about a desired reshaping of specific regions within the fiber under viscous flow.

Some embodiments of the present disclosure provide methods to obtain optical fibers for use in fiber lasers and/or amplifiers. Such methods provide reshaping of specific regions within the fiber to allow more efficient coupling of pump light into the core region of the fiber. Efficient coupling of the pump light into the core may allow shorter overall lengths of fiber to produce any given power level. Shorter overall lengths of fiber can be beneficial to reduce/avoid detrimental effects limiting power output such as Stimulated Brillouin Scattering (SBS) and/or other nonlinear and/or thermal affects, which may increase with fiber length.

In the present disclosure, methods to shape the pedestal region of a fiber are presented. A fiber optic preform may be produced using one or more methods including but not limited to vapor phase methods such as Vapor Axial Deposition (VAD), Modified Chemical Vapor Deposition (MCVD), and/or other vapor phase techniques as well as any number of non-vapor phase methods. The designed preform subsequently has a plurality of voids introduced into the cross section running along the length of the preform (i.e., in an axial direction) surrounding the pedestal region. These voids, for example, can be tubular/cylindrical holes formed by drilling or by stacking tubes adjacent to the pedestal, machined voids of undefined shape (e.g., formed by mechanical and/or laser drilling), or any other hollow region/regions formed in proximity to the pedestal. A preform is thus formed and heated to a temperature at which the material viscosity is such that deformation occurs by stretching or drawing, and under the forces of surface tension, the previously formed voids collapse. Under the forces of collapse, material surrounding the voids may necessarily undergo viscous flow thus deforming any region in close proximity to the original voids. This method allows formation of an unlimited number of different pedestal shapes depending on the size, number and location of voids.

According to first embodiments of inventive concept, an octagonal pedestal may be formed by drilling and/or by using capillaries/rods.

A fiber preform with circular/cylindrical core region, a pedestal region, and an outer clad region may be produced by any method. The preform subsequently has eight holes (also referred to as voids) drilled along its axis in a radially symmetric pattern adjacent to the pedestal region. Raising the temperature of the preform above the glass softening temperature causes the preform to deform by viscous flow. Under stretching and drawing the preform tapers down to a reduced diameter, during which time the holes collapse due to surface tension, producing a fiber with a previously circular pedestal region deformed into a cross section with the hole locations forming the corners of an octagon. Vacuum may be applied to the holes during the draw process to aid in collapse. According to other embodiments, Capillaries/tubes and rods may be alternatingly arranged between the pedestal and clad of the preform such that the capillaries/tubes collapse when heated and drawn into a fiber.

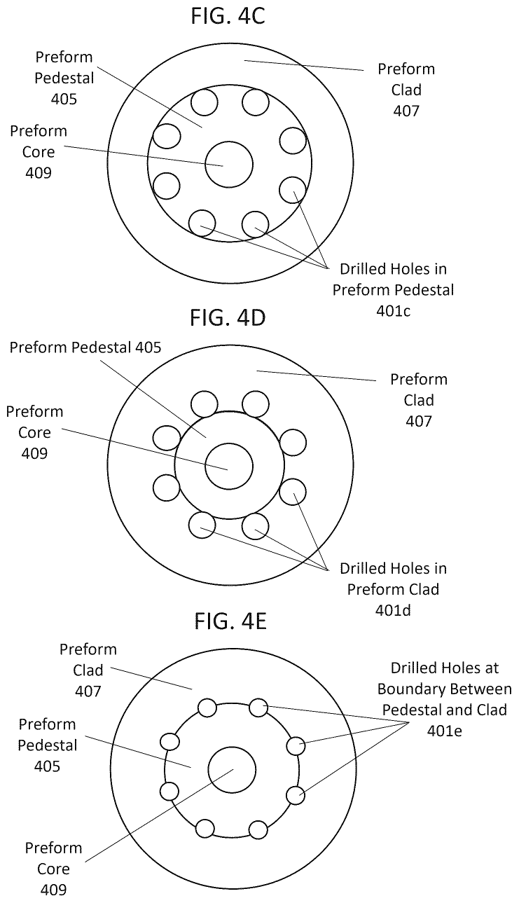

FIGS. 4A and 4B illustrate a stacked octagonal preform before (FIG. 4A) and fiber after (FIG. 4B) drawing/collapsing. As shown, preform pedestal 405 surrounds preform core 409. In FIG. 4A, capillaries/tubes and rods are alternatingly arranged between preform pedestal 405 and preform clad 407, and with 8 capillaries/tubes 401 alternating with 8 rods 403 evenly spaced around the preform pedestal 405. The resulting fiber pedestal 405′ of FIG. 4B may take an octagonal shape after collapsing/stretching/drawing, where fiber core 409′ and fiber clad 407′ are substantially circular in the cross-sectional view of FIG. 4B. Other pedestal shapes may be provided by using different numbers of capillaries/tubes and rods. For example, 6 capillaries/tubes alternating with 6 rods evenly spaced around the pedestal may provide a hexagonal pedestal. FIGS. 4A and 4B are not shown to scale as the drawn fiber of FIG. 4B would have a diameter many times smaller than that of the preform of FIG. 4A.

FIGS. 4C, 4D, and 4E illustrate drilled holes 401c, 401d, and 401e in the preform that may be used instead of the capillaries/tubes 401 of FIG. 4A to provide the fiber structure of FIG. 4B after heating and drawing. In FIG. 4C, the holes 401c are drilled in the preform pedestal 405. In FIG. 4D, the holes 401d are drilled in the preform clad 407. In FIG. 4E, the holes 401e are drilled in the preform at a boundary/interface between the preform pedestal 405 and the preform clad 407.

According to some other embodiments, any combination of capillaries/tubes, rods, and/or drilled holes may be provided in a fiber preform so that a shaped pedestal is provided in the resulting optical fiber after heating and/drawing.

According to second embodiments of inventive concepts, an octagonal pedestal is formed by stacking.

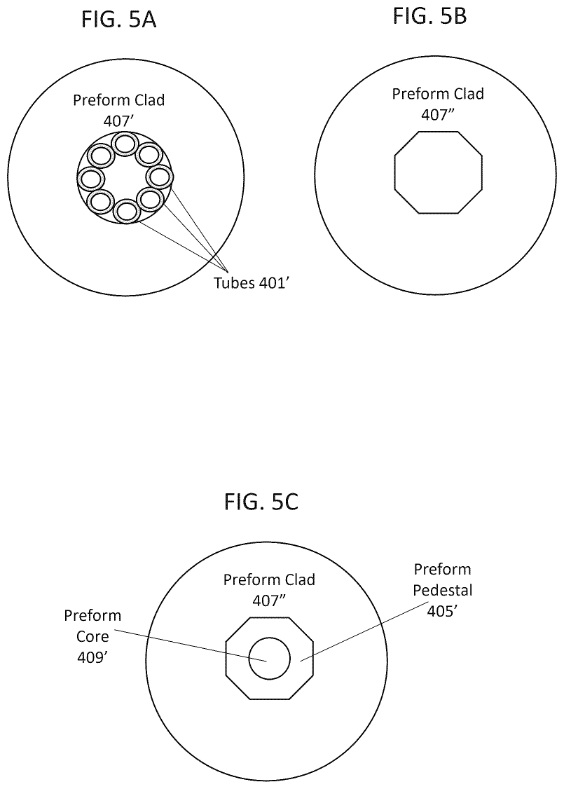

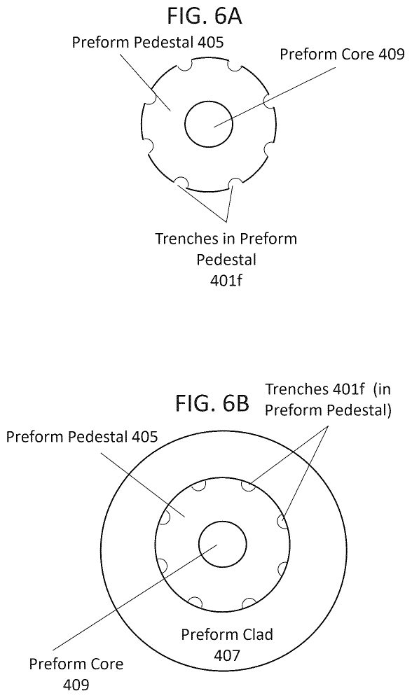

A fiber preform with circular/cylindrical preform core and preform pedestal may be produced by any method. The preform subsequently has eight tubes and eight solid rods alternately stacked along its axis in a radially symmetric pattern adjacent to the pedestal region as shown in FIGS. 4A and 5. FIG. 6A shows a magnified view of the preform pedestal region of FIG. 5. The preform (including preform 409 and preform pedestal 405) and stacked tubes 401 (also referred to as capillaries) are placed inside another larger outer tube to fit closely within the outer tube which provides the preform cladding 407. Raising the temperature of the preform above the glass softening temperature causes the preform to deform by viscous flow. When subjected to stretching and drawing (while heating), the preform tapers down to a reduced diameter, during which time the capillaries/tubes 401 collapse due to surface tension, producing a fiber with a previously circular pedestal region (of the preform) deformed into a cross section with the tube locations forming the corners of an octagon. FIG. 6B is a magnified view the pedestal region of the resulting fiber after heating and drawing, where the resulting fiber of FIG. 6B has a diameter of about 400 μm. Vacuum may be applied to the tubes during the draw process to aid in collapse. The preform is shown in FIGS. 5 and 6A, and the corresponding fiber drawn from the preform of FIGS. 5 and 6A is shown in FIG. 6B.

According to third embodiments of inventive concepts, an octagonal pedestal is formed by machining.

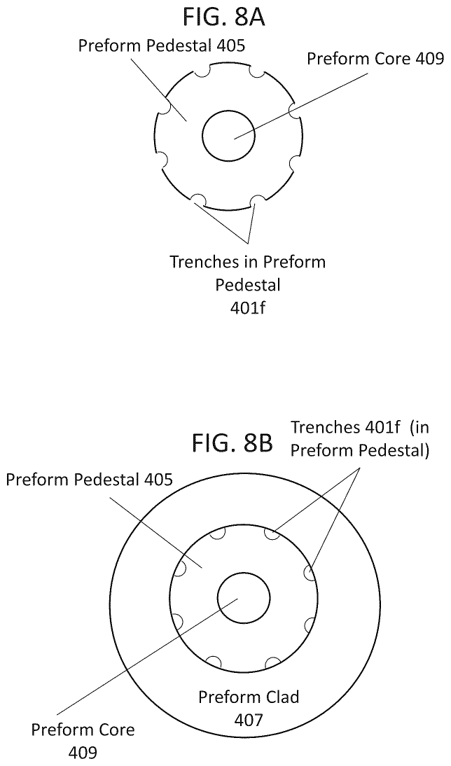

A fiber preform with a circular/cylindrical preform core 409 and a circular/cylindrical preform pedestal 405 may be produced by any method. The preform subsequently has eight trenches 401f machined along its axis (i.e., in an axial direction) in a radially symmetric pattern adjacent to the preform pedestal 405 region as shown in FIG. 8A. The preform with trenches 401f is then placed inside another larger tube (providing preform clad 407) such that the preform with trenches 401f fits closely within the outer tube as shown in FIG. 8B. Raising the temperature of the resulting preform of FIG. 8B above the glass softening temperature causes the preform to deform by viscous flow. Under stretching and drawing the preform of FIG. 8B tapers down to an optical fiber having a reduced diameter, during which time the trenches 401f collapse due to surface tension, producing an optical fiber with a previously circular pedestal region deformed into a cross section with the trench locations forming the corners of an octagon, providing a fiber structure similar to that discussed above with respect to FIGS. 4B and 6B. Vacuum may be applied to the trenches during the draw process to aid in collapse. Stated in other words, trenches 401f provide voids in the preform of FIG. 8B.

According to fourth embodiments of inventive concepts, other fiber cross sections may also be provided.

Other pedestal cross sectional shapes may be formed by varying the number, size, location and/or shape of the voids (e.g., provided using holes, tubes or machined trenches) from the example embodiments discussed above.

According to fifth embodiments of inventive concepts, other fiber cross sections may also be provided.

Other pedestal cross sectional shapes may be formed by varying the number, size, location and/or shape of the voids, with the voids being introduced, by way of example (and not limitation), by drilling, stacking, and/or machining.

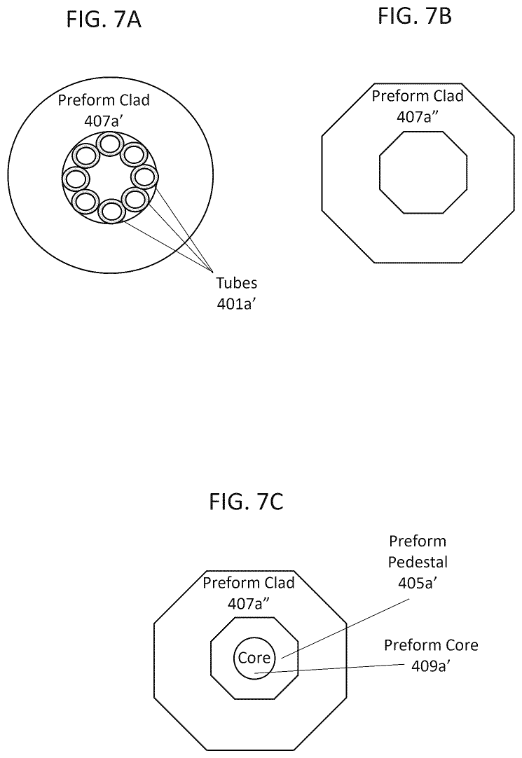

The above discussed methods of the first through fifth embodiments relate to reshaping of a previously formed pedestal region (referred to as a preform pedestal). In some cases, it may be desirable to form a preform clad 407″ with a predetermined shape onto which a preform pedestal can be deposited by vapor phase or other methods as shown in FIGS. 7A, 7B, and 7C. This may be achieved by placing rods, tubes or other shapes on the interior diameter of a larger clad tube 407′ as shown in FIG. 7A (shown with tubes 401′, also referred to as capillaries). Upon heating (and with or without addition of vacuum), the rods, tubes or other shapes (e.g., tubes 401′) fuse to the preform clad' interior and in the case of tubes 401′, collapse. The process of fusion and/or collapse may exert sufficient force such that the interior shape of the preform clad 407″ becomes distorted as shown in FIG. 7B. The shape of the distortion depends on the number size, and location of the rods, tubes or other shapes. Preform pedestal 405′ and preform core 409′ portions of the fiber preform may be formed in the preform clad 407″ using a technique such as vapor phase deposition.

According to sixth embodiments of inventive concepts, an octagonal preform clad interior may be formed from a circular tube prior to pedestal formation.

A preform clad 407′ material in the form of a thick-walled tube has eight hollow tubes 401′ placed along its axis in an axially symmetric pattern tangent to its interior and tangent to each nearest neighboring tube as shown in FIG. 7A. Upon heating to the preform clad 407′ material softening point with or without addition of vacuum to the tubes, the tubes 401′ collapse exerting sufficient force to reshape the interior of the preform clad 407″ tube to form an octagon while the outer diameter of the preform clad 407″ tube remains substantially circular as shown in FIG. 7B. A preform pedestal 405′ and preform core 409′ are then subsequently deposited by vapor phase or any other method to form a shaped region inside the preform clad 407″ tube as shown in FIG. 7C. FIGS. 7A and 7B illustrate shaped preform clad 407′ tube before inner tube collapse (FIG. 7A) and preform clad 407″ tube after inner tube collapse (FIG. 7B).

According to seventh embodiments of inventive concepts, an octagonal cladding interior and exterior may be formed from a circular tube prior to pedestal formation.

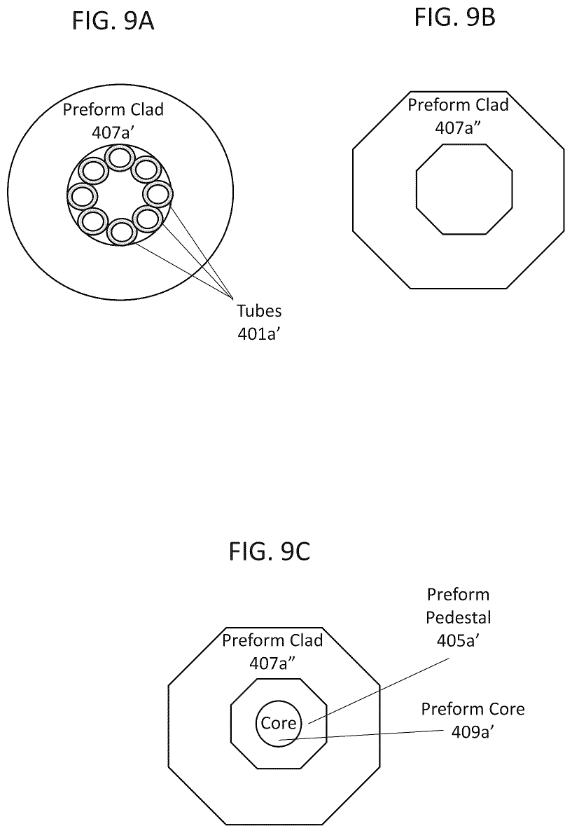

A preform clad 407a′ material in the form of a thin-walled cladding tube has eight hollow tubes 401a′ (also referred to as capillaries) placed along its axis in an axially symmetric pattern tangent to its interior and tangent to each nearest neighboring tube as shown in FIG. 9A. Upon heating to the material softening point with or without addition of vacuum to the tubes, the tubes collapse exerting sufficient force to reshape the interior as well as the exterior of the preform clad 407a″ tube to form an octagon as shown in FIG. 9B. A preform pedestal 405a′ and preform core 409a′ are then subsequently deposited by vapor phase or any other method to form a shaped region as shown in FIG. 9C.

According to eighth embodiments of inventive concepts, other preform clad tube cross sectional shapes may be formed by varying the number, size, location and shape of the rods and tubes in Examples 6 and 7 discussed above according to eighth examples of inventive concepts. A preform pedestal and preform core are then subsequently deposited by vapor phase or any other method to form a shaped region.

According to other embodiments, direct machining of the pedestal area may be provided to achieve a desired form.

Advantages and New Features are discussed below.

The present disclosure teaches novel concepts to reshape the pedestal region of an optical fiber. Optical fibers with non-circular pedestal regions may offer enhanced pump absorption in reduced/minimal length to thus reduce/avoid detrimental SBS and/or other nonlinear and/or thermal affects that may become worse with increasing fiber length. Such fibers may be useful to achieve increased power laser output in fiber-based systems.

According to other embodiments, direct machining of the pedestal area may be provided to achieve a desired form.

### REFERENCE

The following reference is cited above, and the disclosure of this reference is hereby incorporated herein in its entirety by reference.
Reference [1]—N. Simakov, et al. “Design and experimental demonstration of a large pedestal thulium-doped fibre,” Optics Express, Vol. 23, No. 3, pages 3126-3133 (2015).

Additional embodiments of inventive concepts are discussed below.

According to some embodiments of inventive concepts illustrated in FIG. 4A, a fiber preform includes preform core 409, preform pedestal 405 surrounding the preform core 409, and preform clad 407 surrounding the preform pedestal 405. Moreover, the fiber preform includes a plurality of voids adjacent an interface between preform pedestal 405 and preform clad 407, and the voids may be symmetrically arranged around preform core 409 and/or preform pedestal 405. In embodiments of FIG. 4A, the fiber preform includes a plurality of tubes 401 (also referred to as capillaries) between preform pedestal 405 and the preform clad 407, with each of the voids being defined as an interior of a respective one of tubes 401. In addition, the fiber preform of FIG. 4A may include a plurality of rods 403 between preform pedestal 405 and preform clad 407, with each of rods 403 being arranged between two of tubes 401.

The fiber preform of FIG. 4A may be provided, for example, by providing a first preform including preform clad 407 and defining an opening there through and providing a second preform in the opening defined by the first preform. The second preform includes preform core 409 and preform pedestal 405 surrounding preform core 409. In addition, tubes 401 and rods 403 may be provided in the opening defined by the first preform between the first and second preforms, with the voids being defined by interiors of tubes 401 between rods 403. In some embodiments, tubes may be omitted with voids being defined by spaces between rods.

An outer surface of preform core 409 may define a cylinder having an axial direction, and preform core 409 and each of the plurality of voids may extend in the axial direction from a first end of the fiber preform to a second end of the fiber preform. The outer surface of preform clad 407, for example, may define a cylinder having a circular cross-section as shown in FIG. 4A, or the outer surface of preform clad 407 may have a non-circular cross-section such as a polygonal shape (e.g., a hexagonal shape).

As shown in FIG. 4B, the fiber preform of FIG. 4A may be drawn into an optical fiber so that the optical fiber includes fiber core 409′, fiber pedestal 405′ surrounding fiber core 409′, and fiber clad 407′ surrounding fiber pedestal 405′. Moreover, the fiber preform is drawn so that the voids (e.g., interiors of tubes 401) collapse to provide a non-cylindrical interface between fiber pedestal 405′ and fiber clad 407′. A width of the fiber preform of FIG. 4A may be at least 10 times greater than a width of the resulting optical fiber in FIG. 4B. In addition, preform core 409 and fiber core 409′ may have a first refractive index, preform pedestal 405 and fiber pedestal 405′ may have a second refractive index that is less than the first refractive index, and preform clad 407 and fiber clad 407′ may have a third refractive index that is less than the second refractive index.

Drawing the fiber preform of FIG. 4A into the optical fiber of FIG. 4B may include heating the fiber preform to a temperature sufficient to soften the fiber preform, and/or drawing the fiber preform in a vacuum.

According to some embodiments of inventive concepts illustrated in FIGS. 4C, 4D, and 4E, a method of forming an optical fiber is provided. A fiber preform includes preform core 409, preform pedestal 405 surrounding preform core 409, and preform clad 407 surrounding preform pedestal 405, with the fiber preform including a plurality of voids adjacent an interface between the preform pedestal and the preform clad. In addition, the fiber preform may be provided as a solid fiber preform, and the plurality of voids may be drilled into the solid fiber preform, for example, using machine drilling and/or laser drilling. Moreover, an outer surface of preform core 409 may define a cylinder having an axial direction, and preform core 409 and each of the plurality of voids may extend in the axial direction from a first end of the fiber preform to a second end of the fiber preform.

In embodiments of FIGS. 4C, 4D, and 4E, preform core 409 may define an axial direction, and the plurality of voids may extend through the fiber preform in the axial direction adjacent to or at the interface between preform pedestal 405 and preform clad 407. In embodiments of FIG. 4C, each of the voids may extend through preform pedestal 405 in the axial direction adjacent to the interface between preform pedestal 405 and preform clad 407. In embodiments of FIG. 4D, each of the voids may extend through preform clad 407 in the axial direction adjacent to the interface between preform pedestal 405 and preform clad 407. In embodiments of FIG. 4E, each of the voids may extend in the axial direction through portions of preform clad 407 and portions of preform pedestal 405 at the interface between preform clad 407 and preform pedestal 405.

In embodiments of FIGS. 4C, 4D, and 4E, preform core 409 and the fiber core may have a first refractive index, preform pedestal 405 and the fiber pedestal may have a second refractive index that is less than the first refractive index, and preform clad 407 and the fiber clad may have a third refractive index that is less than the second refractive index. In addition, voids 401c, 401d, and/or 401e may be symmetrically arranged around preform pedestal 405.

The fiber preform of any of embodiments of FIGS. 4C, 4D, and/or 4D may be drawn into an optical fiber (as discussed above with respect to FIGS. 4A and 4B) so that the optical fiber includes a fiber core, a fiber pedestal surrounding the fiber core, and a fiber clad surrounding the fiber pedestal, with the fiber preform being drawn so that the voids (401c, 401d, or 401e) collapse to provide a non-cylindrical interface between the fiber pedestal and the fiber clad. Moreover, drawing the fiber preform into the optical fiber may include heating the fiber preform to a temperature sufficient to soften the fiber preform, and/or drawing the fiber preform in a vacuum. In addition, a width of the fiber preform of FIGS. 4C, 4D, and/or 4D may be at least 10 times greater than a width of the resulting optical fiber after being drawn.

According to some embodiments of inventive concepts illustrated in FIGS. 8A and 8B, a method of forming an optical fiber is provided. As shown in FIG. 8B, a fiber preform may include preform core 409, preform pedestal 405 surrounding preform core 409, and preform clad 407 surrounding preform pedestal 405, with the fiber preform including a plurality of voids 401f (also referred to as trenches) adjacent an interface between preform pedestal 405 and the preform clad 407.

More particularly, preform clad 407 may initially be provided as a cylindrical preform clad 407 apart from preform core 409 and preform pedestal 405. Preform core 409 and preform pedestal 405 surrounding preform core 409 may initially be provided apart from preform clad 407, and trenches 401f may be machined into an outer sidewall of preform pedestal 405 as shown in FIG. 8A, with each of trenches 401f providing a respective one of the voids. After machining trenches 401f, preform core 409 and preform pedestal 405 including trenches 401f may be inserted into preform clad 407 as shown in FIG. 8B such that trenches 401f define the voids.

An outer surface of preform core 409 may define a cylinder having an axial direction, and preform core 409 and each of the plurality of trenches 401f may extend in the axial direction from a first end of the fiber preform to a second end of the fiber preform. Moreover, trenches 401f may be symmetrically arranged around preform pedestal 405.

The fiber preform of FIG. 8B may be drawn into the optical fiber (as discussed above with respect to FIGS. 4A and 4B) so that the optical fiber includes a fiber core, a fiber pedestal surrounding the fiber core, and a fiber clad surrounding the fiber pedestal, with the fiber preform being drawn so that the voids collapse to provide a non-cylindrical interface between the fiber pedestal and the fiber clad. Drawing the fiber preform to form the optical fiber may include heating the fiber preform to a temperature sufficient to soften the fiber preform and/or drawing the fiber preform in a vacuum. Moreover, a width of the fiber preform may be at least 10 times greater than a width of the resulting optical fiber. In addition, preform core 409 and the fiber core may have a first refractive index, preform pedestal 405 and the fiber pedestal may have a second refractive index that is less than the first refractive index, and preform clad 407 and the fiber clad may have a third refractive index that is less than the second refractive index.

According to some embodiments illustrated in FIGS. 7A, 7B, and 7C, a method of forming an optical fiber may be provided. Preform clad 407′ may have a cylindrical interior and exterior as shown in FIG. 7A, and preform clad 407′ of FIG. 7A may be reshaped as shown in FIG. 7B so that the interior of preform clad 407″ is non-cylindrical. Reshaping the interior of preform clad 407′ may include providing a plurality of tubes 401′ around the cylindrical interior of preform clad 407′ as shown in FIG. 7A, and heating preform clad 407′ and tubes 401′ so that tubes 401′ collapse to reshape the interior of the preform clad 407″ as shown in FIG. 7B. In FIGS. 7A and 7B, preform clad 407′ may be sufficiently thick so that the cylindrical exterior of preform clad 407″ is substantially maintained in FIG. 7B after reshaping.

After reshaping the interior of preform clad 407″, preform pedestal 405′ and preform core 409′ may be formed on the non-cylindrical interior of preform clad 407″ as shown in FIG. 7C to define a fiber preform including preform core 409′, preform pedestal 405′, and preform clad 407″ having the interior that is non-cylindrical. Preform pedestal 405′ and preform core 409′ may be formed using deposition (e.g., vapor phase deposition).

After forming preform pedestal 405′ and preform core 409′ to define the fiber preform as shown in FIG. 7C, the fiber preform may be drawn into the optical fiber (as discussed above with respect to FIGS. 4A and 4B) so that the optical fiber includes a fiber core, a fiber pedestal surrounding the fiber core, and a fiber clad surrounding the fiber pedestal. Drawing the fiber preform into the optical fiber may include heating the fiber preform to a temperature sufficient to soften the fiber preform and/or drawing the fiber preform in a vacuum.

A width of the fiber preform of FIG. 7C may be at least 10 times greater than a width of the optical fiber drawn from the fiber preform. Moreover, preform core 409′ and the fiber core may have a first refractive index, preform pedestal 405′ and the fiber pedestal may have a second refractive index that is less than the first refractive index, and preform clad 407″ and the fiber clad may have a third refractive index that is less than the second refractive index.

According to some embodiments illustrated in FIGS. 9A, 9B, and 9C, a method of forming an optical fiber may be provided. Preform clad 407a′ may have a cylindrical interior and exterior as shown in FIG. 7A, and preform clad 407a′ of FIG. 9A may be reshaped as shown in FIG. 9B so that the interior and exterior of preform clad 407a″ is non-cylindrical. Reshaping the interior of preform clad 407a′ may include providing a plurality of tubes 401a′ around the cylindrical interior of preform clad 407a′ as shown in FIG. 9A, and heating preform clad 407a′ and tubes 401a′ so that tubes 401a′ collapse to reshape the interior and exterior of the preform clad 407a″ from cylindrical to non-cylindrical as shown in FIG. 9B. In FIGS. 9A and 9B, preform clad 407a′ may be sufficiently thin so that both the interior and exterior of preform clad 407a″ are reshaped from cylindrical to non-cylindrical in FIG. 9B.

After reshaping the interior and exterior of preform clad 407a″, preform pedestal 405a′ and preform core 409a′ may be formed on the non-cylindrical interior of preform clad 407a″ as shown in FIG. 9C to define a fiber preform including preform core 409a′, preform pedestal 405a′, and preform clad 407a″ having the interior that is non-cylindrical. Preform pedestal 405a′ and preform core 409a′ may be formed using deposition (e.g., vapor phase deposition).

After forming preform pedestal 405a′ and preform core 409a′ to define the fiber preform as shown in FIG. 9C, the fiber preform may be drawn into the optical fiber (as discussed above with respect to FIGS. 4A and 4B) so that the optical fiber includes a fiber core, a fiber pedestal surrounding the fiber core, and a fiber clad surrounding the fiber pedestal. Drawing the fiber preform into the optical fiber may include heating the fiber preform to a temperature sufficient to soften the fiber preform and/or drawing the fiber preform in a vacuum.

A width of the fiber preform of FIG. 9C may be at least 10 times greater than a width of the optical fiber drawn from the fiber preform. Moreover, preform core 409a′ and the fiber core may have a first refractive index, preform pedestal 405a′ and the fiber pedestal may have a second refractive index that is less than the first refractive index, and preform clad 407a″ and the fiber clad may have a third refractive index that is less than the second refractive index.

According to some embodiments of inventive concepts illustrated in FIG. 4A, a fiber preform may include preform core 409, preform pedestal 405 surrounding preform core 409, preform clad 407 surrounding preform pedestal 405. Moreover, the fiber preform includes a plurality of voids adjacent an interface between preform pedestal 405 and preform clad 407. In FIG. 4A, the fiber preform further includes a plurality of tubes 401 (also referred to as capillaries) between preform pedestal 405 and preform clad 407, with each of the voids being defined as an interior of a respective one of tubes 401. In FIG. 4A, the fiber preform may further include a plurality of rods 403 between preform pedestal 405 and preform clad 407, with each of rods 403 being arranged between two of tubes 401.

An outer surface of preform core 409 may define a cylinder having an axial direction, and preform core 409 and each of the plurality of voids (e.g., tubes 401) may extend in the axial direction from a first end of the fiber preform to a second end of the fiber preform. Moreover, preform core 409 may have a first refractive index, preform pedestal 405 may have a second refractive index that is less than the first refractive index, and preform clad 407 may have a third refractive index that is less than the second refractive index.

According to some embodiments of inventive concepts illustrated in FIGS. 4C, 4D, and 4E, a fiber preform may include preform core 409, preform pedestal 405 surrounding preform core 409, and preform clad 407 surrounding preform pedestal, with the fiber preform including a plurality of voids adjacent an interface between preform pedestal 405 and preform clad 407. An outer surface of preform core 407 may define a cylinder having an axial direction, and preform core 409 and each of the plurality of voids may extend in the axial direction from a first end of the fiber preform to a second end of the fiber preform. As shown in FIG. 4C, the plurality of voids may extend through preform pedestal 405 in the axial direction adjacent to the interface. As shown in FIG. 4D, the plurality of voids may extend through preform clad 407 in the axial direction adjacent to the interface. As shown in FIG. 4E, the plurality of voids may extend through the fiber preform in the axial direction at the interface.

In embodiments of FIGS. 4C, 4D, and 4E, preform core 409 may have a first refractive index, preform pedestal 405 may have a second refractive index that is less than the first refractive index, and preform clad 407 may have a third refractive index that is less than the second refractive index. Moreover, the voids of FIGS. 4C, 4D, and 4E may be symmetrically arranged around preform core 409.

According to some embodiments of inventive concepts illustrated in FIG. 8B, a fiber preform may include preform core 409, preform pedestal 405 surrounding preform core 409, and preform clad 407 surrounding preform pedestal 405, fiber pedestal 405 including a plurality of trenches 401f adjacent an interface between preform pedestal 405 and preform clad 407. Each of trenches 401f may be provided in an outer sidewall of preform pedestal 405 adjacent an inner sidewall of preform clad 407, and trenches 401f may be symmetrically arranged around preform core 409.

An outer surface of preform core 409 may define a cylinder having an axial direction, and preform core 409 and each of the plurality of trenches 401f may extend in the axial direction from a first end of the fiber preform to a second end of the fiber preform. Moreover, preform core may have a first refractive index, preform pedestal 405 may have a second refractive index that is less than the first refractive index, and preform clad 407 may have a third refractive index that is less than the second refractive index.

According to some embodiments of inventive concepts illustrated in FIG. 4A, a fiber preform may include a first preform defining preform clad 407 having an opening there through, and a second preform in the opening defined by the first preform, with the second preform including preform core 409 and preform pedestal 405 surrounding preform core 409. In addition, a plurality of spaced apart rods 403 are included in the opening defined by the first preform between the first and second preforms, wherein voids are defined between the rods. In addition, rods 403 may be symmetrically arranged around preform core 409. The fiber preform may also include a plurality of tubes 401 with each of tubes 401 be located between two of rods 403.

Further embodiments of inventive concepts are provided below.
Embodiment 1. A method of forming an optical fiber, the method comprising: providing a fiber preform including a preform core, a preform pedestal surrounding the preform core, and a preform clad surrounding the preform pedestal, wherein the fiber preform includes a plurality of voids adjacent an interface between the preform pedestal and the preform clad; and drawing the fiber preform into the optical fiber so that the optical fiber includes a fiber core, a fiber pedestal surrounding the fiber core, and a fiber clad surrounding the fiber pedestal, wherein the fiber preform is drawn so that the voids collapse to provide a non-cylindrical interface between the fiber pedestal and the fiber clad.
Embodiment 2. The method of Embodiment 1, wherein an outer surface of the preform core defines a cylinder having an axial direction, and wherein the preform core and each of the plurality of voids extends in the axial direction from a first end of the fiber preform to a second end of the fiber preform.
Embodiment 3. The method of any of Embodiments 1-2, wherein drawing the fiber preform into the optical fiber comprises heating the fiber preform to a temperature sufficient to soften the fiber preform.
Embodiment 4. The method of any of Embodiments 1-3, wherein drawing the fiber preform into the optical fiber comprises drawing the fiber preform in a vacuum.
Embodiment 5. The method of any of Embodiments 1-4, wherein a width of the fiber preform is at least 10 times greater than a width of the optical fiber.
Embodiment 6. The method of any of Embodiments 1-5, wherein the preform core and the fiber core have a first refractive index, wherein the preform pedestal and the fiber pedestal have a second refractive index that is less than the first refractive index, and wherein the preform clad and the fiber clad have a third refractive index that is less than the second refractive index.
Embodiment 7. The method of any of Embodiments 1-6, wherein the preform core defines an axial direction, and wherein the plurality of voids extend through the preform pedestal in the axial direction adjacent to the interface.
Embodiment 8. The method of any of Embodiments 1-6, wherein the preform core defines an axial direction, and wherein the plurality of voids extend through the preform clad in the axial direction adjacent to the interface.
Embodiment 9. The method of any of Embodiments 1-6, wherein the preform core defines an axial direction, and wherein the plurality of voids extend through the fiber preform in the axial direction at the interface.
Embodiment 10. The method of any of Embodiments 1-9, wherein providing the fiber preform comprises providing a solid fiber preform and drilling the plurality of voids into the solid fiber preform.
Embodiment 11. The method of Embodiment 10, wherein drilling comprises machine drilling and/or laser drilling.
Embodiment 12. The method of any of Embodiments 1-6, wherein the fiber preform further includes a plurality of tubes between the preform pedestal and the preform clad, wherein each of the voids is defined as an interior of a respective one of the tubes.
Embodiment 13. The method of Embodiment 12, wherein the fiber preform further includes a plurality of rods between the preform pedestal and the preform clad, wherein each of the rods is arranged between two of the tubes.
Embodiment 14. The method of any of Embodiments 1-6, wherein providing the fiber preform comprises, providing the preform clad as a cylindrical preform clad, providing the preform core and the preform pedestal surrounding the preliminary preform core apart from the preform clad, machining trenches into an outer sidewall of the preform pedestal, wherein each of the trenches corresponds to a respective one of the voids, and after machining the trenches, inserting the preform core and the preform pedestal including the trenches into the preform clad such that the trenches define the voids.
Embodiment 15. The method of any of Embodiments 1-6, wherein providing the fiber preform comprises, providing a first preform including the preform clad, wherein the first preform defines an opening there through; providing a second preform in the opening defined by the first preform, wherein the second preform includes the preform core and the preform pedestal surrounding the preform core; and providing a plurality of spaced apart rods in the opening defined by the first preform between the first and second preforms, wherein the voids are defined between the rods.
Embodiment 16. The method of any of Embodiments 1-15, wherein the voids are symmetrically arranged around the preform pedestal.
Embodiment 17. A method of forming an optical fiber, the method comprising: providing a preform clad having a cylindrical interior and exterior; reshaping the preform clad so that the interior of the preform clad is non-cylindrical; after reshaping the interior of the preform clad, forming a preform pedestal and a preform core on the non-cylindrical interior of the preform clad to define a fiber preform including the preform core, the preform pedestal, and the preform clad having the interior that is non-cylindrical; and after forming the preform pedestal and the preform core to define the fiber preform, drawing the fiber preform into the optical fiber so that the optical fiber includes a fiber core, a fiber pedestal surrounding the fiber core, and a fiber clad surrounding the fiber pedestal.
Embodiment 18. The method of Embodiment 17, wherein reshaping the interior of the preform clad comprises, providing a plurality of tubes around the cylindrical interior, and heating the preform clad and the tubes so that the tubes collapse to reshape the interior of the preform clad.
Embodiment 19. The method of any of Embodiments 17-18, wherein reshaping comprises reshaping the preform clad so that the interior and the exterior of the preform clad are non-cylindrical.
Embodiment 20. The method of any of Embodiments 17-19, wherein forming the preform pedestal and the preform core comprises forming the preform pedestal and the preform core using deposition.
Embodiment 21. The method of Embodiment 20, wherein the deposition comprises vapor phase deposition.
Embodiment 22. The method of any of Embodiments 17-21, wherein drawing the fiber preform into the optical fiber comprises heating the fiber preform to a temperature sufficient to soften the fiber preform.
Embodiment 23. The method of any of Embodiments 17-22, wherein drawing the fiber preform into the optical fiber comprises drawing the fiber preform in a vacuum.
Embodiment 24. The method of any of Embodiments 17-23, wherein a width of the fiber preform is at least 10 times greater than a width of the optical fiber.
Embodiment 25. The method of any of Embodiments 17-24, wherein the preform core and the fiber core have a first refractive index, wherein the preform pedestal and the fiber pedestal have a second refractive index that is less than the first refractive index, and wherein the preform clad and the fiber clad have a third refractive index that is less than the second refractive index.
Embodiment 26. A fiber preform comprising: a preform core; a preform pedestal surrounding the preform core; and a preform clad surrounding the preform pedestal, wherein the fiber preform includes a plurality of voids adjacent an interface between the preform pedestal and the preform clad.
Embodiment 27. The fiber preform of Embodiment 26, wherein an outer surface of the preform core defines a cylinder having an axial direction, and wherein the preform core and each of the plurality of voids extends in the axial direction from a first end of the fiber preform to a second end of the fiber preform.
Embodiment 28. The fiber preform of any of Embodiments 26-27, wherein the preform core has a first refractive index, wherein the preform pedestal has a second refractive index that is less than the first refractive index, and wherein the preform clad has a third refractive index that is less than the second refractive index.
Embodiment 29. The fiber preform of any of Embodiments 26-28, wherein the preform core defines an axial direction, and wherein the plurality of voids extend through the preform pedestal in the axial direction adjacent to the interface.
Embodiment 30. The fiber preform of any of Embodiments 26-28, wherein the preform core defines an axial direction, and wherein the plurality of voids extend through the preform pedestal in the axial direction adjacent to the interface.
Embodiment 31. The fiber preform of any of Embodiments 26-28, wherein the preform core defines an axial direction, and wherein the plurality of voids extend through the fiber preform in the axial direction at the interface.
Embodiment 32. The fiber preform of any of Embodiments 26-28, wherein the fiber preform further includes a plurality of tubes between the preform pedestal and the preform clad, wherein each of the voids is defined as an interior of a respective one of the tubes.
Embodiment 33. The fiber preform of Embodiment 32, wherein the fiber preform further includes a plurality of rods between the preform pedestal and the preform clad, wherein each of the rods is arranged between two of the tubes.
Embodiment 34. The fiber preform of any of Embodiments 26-28, wherein each of the plurality of voids comprises a respective trench in an outer sidewall of the preform pedestal adjacent an inner sidewall of the preform clad, wherein each of the trenches corresponds to a respective one of the voids.
Embodiment 35. The fiber preform of any of Embodiments 26-34, wherein the voids are symmetrically arranged around the preform core.
Embodiment 36. A fiber preform comprising: a first preform defining a preform clad having an opening there through; a second preform in the opening defined by the first preform, wherein the second preform includes a preform core and a preform pedestal surrounding the preform core; and a plurality of spaced apart rods in the opening defined by the first preform between the first and second preforms, wherein voids are defined between the rods.
Embodiment 37. The fiber preform of Embodiment 36, wherein the rods are symmetrically arranged around the preform core.

Methods of forming fibers as disclosed herein may be used to provide high power fiber lasers by increasing coupling of energy into the fiber core. Such fiber lasers may be useful for illumination and/or directed energy applications.

Additional definitions are provided below.

The terminology used herein is for the purpose of describing particular embodiments only and is not intended to be limiting of example embodiments and/or claims. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on”, “connected” to/with, or “coupled” to/with another element, it can be directly on, connected to/with, or coupled to/with the other element, or intervening elements may be present. In contrast, when an element is referred to as being “directly on”, “directly connected” to/with, or “directly coupled” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated as a rectangle or other polygon may, typically, have rounded or curved features and/or a gradient of refractive index at its edges rather than a binary change from one refractive index to another refractive index. Thus, the regions illustrated in the figures are schematic in nature and their shapes are not intended to illustrate the actual shape of a region of a device and are not intended to limit the scope of the present inventive concepts.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

Unless otherwise defined, all terms (including technical and scientific terms) used herein have the same meaning as commonly understood by one of ordinary skill in the art to which inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. A method of forming an optical fiber, the method comprising:
providing a fiber preform including a preform core, a preform pedestal surrounding the preform core, and a preform clad surrounding the preform pedestal, wherein the fiber preform includes a plurality of voids adjacent an interface between the preform pedestal and the preform clad; and
drawing the fiber preform into the optical fiber so that the optical fiber includes a fiber core, a fiber pedestal surrounding the fiber core, and a fiber clad surrounding the fiber pedestal, wherein the fiber preform is drawn so that the voids collapse to provide a non-cylindrical interface between the fiber pedestal and the fiber clad.

2. The method of claim 1, wherein an outer surface of the preform core defines a cylinder having an axial direction, and wherein the preform core and each of the plurality of voids extends in the axial direction from a first end of the fiber preform to a second end of the fiber preform.

3. The method of claim 1, wherein the preform core and the fiber core have a first refractive index, wherein the preform pedestal and the fiber pedestal have a second refractive index that is less than the first refractive index, and wherein the preform clad and the fiber clad have a third refractive index that is less than the second refractive index.

4. The method of claim 1, wherein the preform core defines an axial direction, and wherein the plurality of voids extend through the fiber preform in the axial direction adjacent to the interface.

5. The method of claim 1, wherein the preform core defines an axial direction, and wherein the plurality of voids extend through the fiber preform in the axial direction at the interface.

6. The method of claim 1, wherein providing the fiber preform comprises providing a solid fiber preform and drilling the plurality of voids into the solid fiber preform.

7. The method of claim 1, wherein the fiber preform further includes a plurality of tubes between the preform pedestal and the preform clad, wherein each of the voids is defined as an interior of a respective one of the tubes.

8. The method of claim 7, wherein the fiber preform further includes a plurality of rods (403) between the preform pedestal and the preform clad, wherein each of the rods is arranged between two of the tubes.

9. The method of claim 1, wherein providing the fiber preform comprises,
providing the preform clad as a cylindrical preform clad,
providing the preform core and the preform pedestal surrounding the preliminary preform core apart from the preform clad,
machining trenches into an outer sidewall of the preform pedestal, wherein each of the trenches corresponds to a respective one of the voids, and
after machining the trenches, inserting the preform core and the preform pedestal including the trenches into the preform clad such that the trenches define the voids.

10. The method of claim 1, wherein providing the fiber preform comprises,
providing a first preform including the preform clad, wherein the first preform defines an opening there through;
providing a second preform in the opening defined by the first preform, wherein the second preform includes the preform core and the preform pedestal surrounding the preform core; and
providing a plurality of spaced apart rods in the opening defined by the first preform between the first and second preforms, wherein the voids are defined between the rods.

11. A method of forming an optical fiber, the method comprising:
providing a preform clad having a cylindrical interior and exterior;
reshaping the preform clad so that the interior of the preform clad is non-cylindrical;
after reshaping the interior of the preform clad, forming a preform pedestal and a preform core on the non-cylindrical interior of the preform clad to define a fiber preform including the preform core, the preform pedestal, and the preform clad having the interior that is non-cylindrical; and
after forming the preform pedestal and the preform core to define the fiber preform, drawing the fiber preform into the optical fiber so that the optical fiber includes a fiber core, a fiber pedestal surrounding the fiber core, and a fiber clad surrounding the fiber pedestal.

12. The method of claim 11, wherein reshaping the interior of the preform clad comprises,
providing a plurality of tubes around the cylindrical interior, and
heating the preform clad and the tubes so that the tubes collapse to reshape the interior of the preform clad.

13. The method of claim 11, wherein reshaping comprises reshaping the preform clad so that the interior and the exterior of the preform clad are non-cylindrical.

14. A fiber preform comprising:
a preform core;
a preform pedestal surrounding the preform core; and
a preform clad surrounding the preform pedestal, wherein the fiber preform includes a plurality of voids adjacent an interface between the preform pedestal and the preform clad.

15. The fiber preform of claim 14, wherein an outer surface of the preform core defines a cylinder having an axial direction, and wherein the preform core and each of the plurality of voids extends in the axial direction from a first end of the fiber preform to a second end of the fiber preform.

16. The fiber preform of claim 14, wherein the preform core defines an axial direction, and wherein the plurality of voids extend through the preform pedestal in the axial direction adjacent to the interface.

17. The fiber preform of claim 14, wherein the fiber preform further includes a plurality of tubes between the preform pedestal and the preform clad, wherein each of the voids is defined as an interior of a respective one of the tubes.

18. The fiber preform of claim 17, wherein the fiber preform further includes a plurality of rods between the preform pedestal and the preform clad, wherein each of the rods is arranged between two of the tubes.

19. The fiber preform of claim 14, wherein each of the plurality of voids comprises a respective trench in an outer sidewall of the preform pedestal adjacent an inner sidewall of the preform clad, wherein each of the trenches corresponds to a respective one of the voids.

20. A fiber preform comprising:
a first preform defining a preform clad having an opening therethrough;
a second preform in the opening defined by the first preform, wherein the second preform includes a preform core and a preform pedestal surrounding the preform core; and
a plurality of spaced apart rods in the opening defined by the first preform between the first and second preforms, wherein voids are defined between the rods.
